(19) United States
(12) Patent Application Publication
(10) Pub. No.: US 2004/0124253 A1
(43) Pub. Date: Jul. 1, 2004

(54) Injection apparatus for irrigation system

(76) Inventors: Gregory A. Bergwin, Weatherford, TX (US); Corby A. Davis, Liberty Hill, TX (US)

Correspondence Address: James E. Bradley, Bracewell & Patterson, LLP, P.O. Box 61389, Houston, TX, 77208-1389, US

(21) Appl. No.: 10/688,599

(22) Filed: Oct. 17, 2003

Related U.S. Application Data
(60) Provisional application No. 60/419,131, filed on Oct. 17, 2002.

(51) Int. Cl. A62C 5/02; B05B 12/08

(52) U.S. Cl. 239/10; 239/310; 239/318; 239/67; 239/68; 239/63

(57) ABSTRACT

An irrigation system provides fertilization by distributing a chemical additive onto a soil such as a golf course. The irrigation commences with a flowline carrying water, and a pump pumps a chemical additive directly into the flowline. The chemical additive mixes with the water, and the mixture ultimately reaches a sprinkler head where it is sprayed onto the soil for treatment. A reservoir, pump, motor, and control system are enclosed within a housing. The reservoir holds an additive and is connected to the pump, allowing the additive to flow from the reservoir to the pump. The motor operates the pump, which pumps the additive into the flowline. At least one sensor monitors at least one characteristic of the additive. The feedback control system reads the feedback data from the sensors, controlling the flow rate of the additive through the pump into the flowline.

### RELATED APPLICATIONS

This application claims the benefit of provisional application with the U.S. Serial No. 60/419,131, filed on Oct. 17, 2002, which hereby is incorporated by reference in its entirety.

### 1. FIELD OF THE INVENTION

The present invention relates generally to fertilizer irrigation systems, and more particularly to systems pumping additive into a water flowline and through a sprinkler head onto soil for treatment.

### 2. BACKGROUND OF THE INVENTION

Golf courses and many other lawns need to be fertilized in order to maintain the proper utility and appearance. For example, golf courses have various species of turf grasses used on fairways, tees, greens, and other areas of the lawn, all of which need to be fertilized.

Fertilization is typically handled by distributing the fertilizer on the lawn. This may be done with a spreader in the case of pellet fertilizer. It also may be achieved by preparing a liquid fertilizer solution, and then spraying it through a tank onto the lawn. Watering of the lawn is typically done separately, such as through underground flowlines and sprinkler heads.

As competition in the golf course industry intensifies, it will become increasingly important to provide each respective species of grass turf with the appropriate amount of additive to enhance the utility and appearance of the lawn. For this reason, a need exists in the art for an irrigation system whereby sensor devices can continually monitor the characteristics of the additive throughout the irrigation system, the flowline, and the soil. In this sense, immediate and continuous sensory feedback will enable the system to vary the flow rate of additive pumped into the water flowline by the second (or even by the millisecond), thus providing ratios of additive and water that maximize irrigation performance, and ultimately maximizing the utility and appearance of the golf course or other lawn.

### 3. SUMMARY

In the present invention, an irrigation system provides fertilization by distributing a liquid chemical additive onto a soil such as a golf course. The irrigation commences with a flowline carrying water, such as an underground flowline. The present invention pumps a chemical additive directly into the flowline. The chemical additive mixes with the water flowing through the flowline, and the mixture of additive and water ultimately reaches a sprinkler head, where it is sprayed onto the soil for treatment.

In one embodiment of the present invention, the irrigation system comprises a reservoir, pump, motor, and control system, all enclosed within a housing. The reservoir holds a chemical additive, and is connected to the pump using a conduit, allowing the additive to flow from the reservoir to the pump. The motor operates the pump, which may be a positive displacement pump, delivering the additive into the flowline. In another embodiment, the pump delivers the additive into the flowline at a flow rate in the range of 0-150 gallons per hour. Further, in another embodiment, the pump delivers the additive into the flowline at a constant flow rate.

At least one sensor monitors at least one characteristic of the additive as it flows through the irrigation system. The feedback control system reads the feedback data from the sensors, and then controls the flow rate of the additive through the pump into the flowline.

In one embodiment, at least one sensor positioned in the flowline reads such characteristics as flow rate or pH level of the additive and water mixture in the flowline. In another embodiment, a sensor embedded in a soil sample reads the characteristics of the additive present in the soil. Further, in another embodiment, a sensor positioned in the reservoir reads such characteristics as fluid level depth of the additive in the reservoir. The sensors in the present invention are able to read the feedback data in increments of 50 milliseconds or more.

### 4. BRIEF DESCRIPTION OF THE DRAWINGS

The novel features believed to be characteristic of the invention are set forth in the appended claims. The invention itself however, as well as a preferred mode of use, and advantages thereof, will best be understood by reference to the following detailed description of an illustrative embodiment when read in conjunction with the accompanying drawings.

FIG. 1 is a schematic side view of a portion of an injection apparatus according to the invention and connected to an irrigation system.

FIG. 2 is a cross-sectional side view of the pump of the apparatus of FIG. 1.

FIG. 3 is a schematic side view of the apparatus of FIG. 1 installed at a location and connected to a remote sensor.

### 5. DETAILED DESCRIPTION OF THE INVENTION

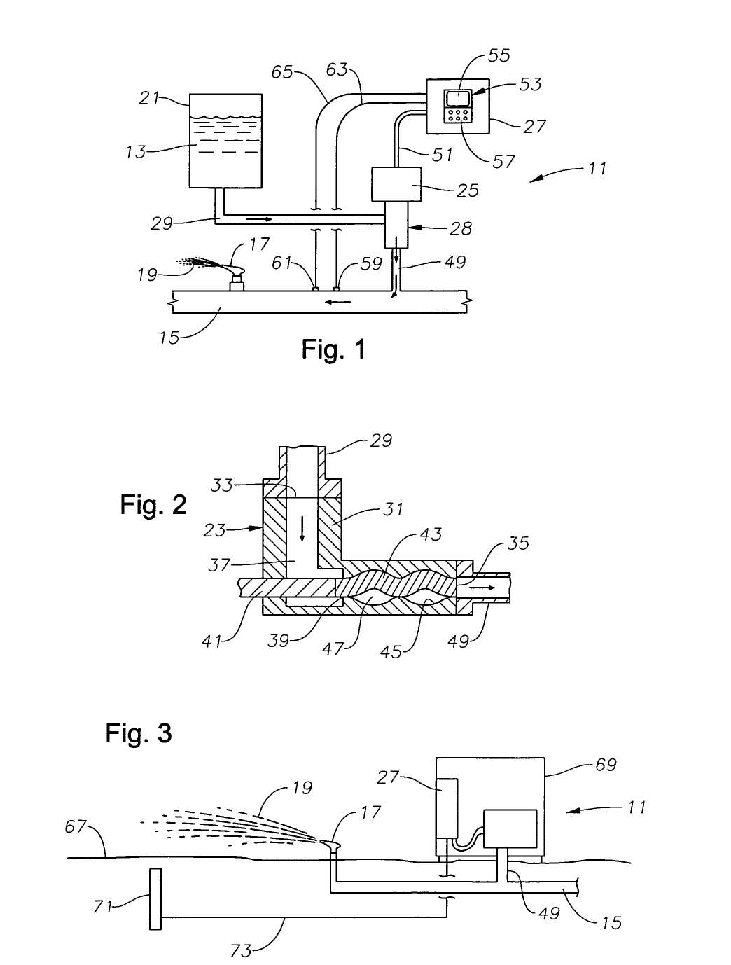

FIGS. 1 through 3 illustrate an apparatus 11 for injecting a liquid additive 13 into a flowline 15 of an irrigation system. Apparatus 11 is typically installed at golf courses or other locations having irrigation systems used to spray or otherwise deliver water to large areas, for example, agricultural fields.

FIG. 1 is a schematic view of apparatus 11 connected to flowline 15. Flowline 15 carries a high-volume, high-pressure (typically 140-180 psi) supply of water from a pressure source (not shown) to a plurality of delivery devices, such as sprinkler head 17 or a similar device. Sprinkler head 17 ejects water as a spray 19 in selected directions and at selected locations of the area being irrigated. To provide additional nutrients (i.e., fertilizer) or to deliver other additives (e.g., herbicides, pesticides, etc.) for application to foliage or absorption into the soil surrounding each sprinkler head 17, apparatus 11 selectively injects additive 13 into flowline 15 for mixing with water in flowline 15, the water-additive 13 mixture being ejected as spray 19.

Apparatus 11 comprises a tank 21, a pump 23, a motor 25, and a control system 27. Tank 21 is sized for storing a sufficient volume of additive 13 and dispenses stored additive 13 as apparatus 11 injects additive 13 into flowline 15. Tank 21 is formed from a material that is impervious to the chemical characteristics of additive 13, for example, whether additive 13 is caustic or acidic. Tank 21 is connected to an intake of pump 23 with conduit 29 for continuously providing additive 13 to pump 23 for injection. Though shown with only one tank 21, pump 23, and motor 25, which together form an injection unit, apparatus 11 may have additional injection units for simultaneously or separately dispensing multiple additives 13.

Pump 23 is of the “positive displacement” (PD), or progressive cavity, type, and is shown in detail in FIG. 2. Pump 23 is preferably rated for pumping 0-150 gallons per hour (gph) and is formed from a polymer material for chemical resistance to additive 13. The use of a PD pump, rather than a diaphragm pump, as used in prior-art systems, has several advantages. A PD pump provides for more precise control over the amounts of additive 13 injected into flowline 15 by providing a constant feed of additives per revolution, which allows for a level of metering that ranges to parts-per-million (ppm), if desired. For example, PD pumps are often used to dispense soft-drink syrups, which is an application requiring delivery of precise amounts. In addition, a PD pump maintains its prime at all flow rates, whereas a diaphragm pump may lose its prime below approximately 10% of its rated capacity. Though diaphragm pumps may be run at speeds other than their rated speed, the pumps are inefficient at these other speeds, and pumps of different size often need to be installed to achieve proper delivery at the desired volume rates. An added benefit is that PD pumps are generally less expensive than diaphragm pumps.

Pump 23 has a body 31 with an inlet 33 and an outlet 35, which are located at opposing ends of body 31. Conduit 29 is connected to inlet 33, which opens into flow path 37 for providing additive 13 to cavity inlet 39. A shaft 41 connected to motor 25 (FIG. 1) extends into body 31 for rotating a helical rotor 43 within a stator profile 45 formed within body 31, rotor 43 and stator 45 cooperating to form cavities 47 that progress toward outlet 35 as rotor 43 rotates. As cavities 47 reach outlet 35, additive 13 is dispensed out of pump 23 into conduit 49, which communicates pump 23 with flowline 15. Rotor 43 is preferably formed from a polymer, requiring that additive 13 be present in pump 23 when pump 23 is operating, as the polymer will be damaged to failure if pump 23 runs dry.

Referring again to FIG. 1, to selectively control the amount of additive 13 dispensed by pump 23, motor 25 is operated by control system 27. Motor 25 is a servomotor, with data and electrical power communicated between motor 25 and control system 27 through cables 51. The use of a servo-type motor 25 provides greater accuracy than can be achieved with encoder, or stepper, motors, and allows for control system 27 to precisely control the rotation of motor 25. Motor 25 can be rotated at any speed up to the rated maximum and can be rotated to a particular angular position or through a selected angle.

The operator interfaces with control system 27 at control panel 53, which comprises a display screen 55 and interface device 57, such as a keypad. Alternatively, display screen 55 and interface device 57 may be incorporated in the same device, such as a touchscreen device. Control panel 53 is used by the operator to command control system 27 for injecting additive 13 at rates selected to produce desired levels of application though sprinkler heads 17. For soil nutrients, these levels are typically measured for nitrogen, phosphorous, and potassium (NPK). For example, the operator may directly input the levels of NPK to be applied, or the control system may calculate the appropriate levels from test results of soil samples and from data collected from remote water or soil sensors. The ratios are typically calculated in pounds per acre or pounds per 1000 square feet.

Control system 27 may determine the need for injection of additive 13 by sampling data from sensors in communication with the fluid flow in flowline 15. Sensors preferably include pH sensor 59, for measuring the pH of the fluid in flowline 15, and flow meter 61, for measuring the flow rate in flowline 15. Sensor 59 and meter 61 are shown as being located downstream of the point where conduit 49 opens into flowline 15, and wires 63, 65 carry data from pH sensor 59 and flow meter 61, respectively, to control system 27. Sensors 59, 61 provide measurement of the characteristics of the flow after injection of additive 13, and control system 27 can regulate the addition of additive 13 in response to the data. For example, additive 13 may be acidic, and pH sensor 59 will indicate the pH level after injection of additive 13. Control system 27, which is preferably a closed-loop, PID type, can then adjust the rate of injection of additive 13 to bring the pH level to the desired value with minimal overshoot. Control system 27 may also be used to control the amount of water flowing through flowline 15 in response to the data provided by flow meter 61. Sensors 59, 61 and/or additional sensors (not shown) may be located upstream of the injection point for measuring the characteristics of the supply water prior to injection. A fluid level sensor may be mounted in tank 21 and connected to control system 27, allowing control system 27 to cease operation of pump 23 when the amount of additive 13 in tank 21 reaches a selected lower level.

FIG. 3 shows apparatus 11 installed at a site having an irrigation system for irrigating soil 67. Apparatus 11 is enclosed in housing 69 and connected to flow line 15, which provides water to sprinkler head 17 for producing spray 19, apparatus 11 injecting additive 13 into flowline 15 through conduit 49. To provide additional information to control system 27, optional soil sensors 71 are installed in soil 67 for monitoring the characteristics of soil 67, such as pH level, moisture level, and/or monitoring the levels of additive 13 present in soil 67. A cable 73 carries data from each sensor 71 to control system 27 on a real-time basis, allowing control system 27 to continually adjust the injection rate based on the data from soil sensors 71.

Preferably, control system 27 reads the output from pH sensor 59, flow meter 61, and soil sensor 71 in 50 millisecond increments or more. The following example will illustrate the accuracy gained from using pump 23. Pump 23 is preferably rated at 150 gph at 1750 rpm. Dividing this by the number of seconds in an hour and the number of reads per second while multiplying by the number of ounces in a gallon, it is calculated that the pump delivers approximately 0.267 ounces of additive 13 per read by the control system at the rated maximum flow. Since the speed of motor 25 is varied by control system 27, pump 23 is not always operating at the maximum capacity, and the amount of additive 13 delivered per read is smaller in direct proportion to the slower speed.

In addition, use of a servomotor allows for accurate control of the rotational position of rotor 43 in pump 23. For example, for pump 23 having the rated capacity discussed above, dividing the capacity by the revolutions per hour and 360 degrees while multiplying by the number of ounces in a gallon, it is calculated that pump 23 delivers 0.000509 ounces per degree of revolution of rotor 43. This is a constant amount per revolution, regardless of the speed of rotor 43, though motor 25 may be of a type that provides greater accuracy, for example, to accuracy in the range of seconds of a degree.

Referring to the figures, in operation, the operator inputs soil sample data or manually inputs desired continual levels of additive 13 into control system 27, which may calculate the required amounts of additive 13 to add to inject into flowline 15. Control system may incorporate data from sensors 59, 61, 71 in these calculations. Control system 27 then operates motor 25 to rotate rotor 43 of pump 23, injecting additive 13 into flowline 15. Control system 27 operates motor 25 at the rotational speed or through the angle required to inject additive 13 at a rate sufficient to cause the desired amounts to be delivered through sprinkler heads 17 in spray 19. Control system 27 continually recalculates the rate of injection to maintain the desired levels of additive 13 in spray 19 by regulating the speed or position of motor 25.

While the invention has been described in only one of its forms, it should be apparent to those skilled in the art that it is not so limited, but is susceptible to various changes without departing from the scope of the invention.

That which is claimed is:

1. An irrigation system for fertilizing soil through a water flowline and a sprinkler head, comprising:
a reservoir for holding an additive;
a pump connected to an outlet of the reservoir, which injects the additive into the flowline;
at least one sensor that monitors a characteristic of the additive; and
a feedback control system that reads data from the sensor and controls the flow rate of the additive through the pump.

2. The system of claim 1, wherein the sensor is adapted to be positioned in the flowline.

3. The system of claim 2, wherein the sensor comprises a flow meter adapted to be positioned in the flowline.

4. The system of claim 2, wherein the sensor comprises a pH sensor adapted to be positioned in the flowline.

5. The system of claim 1, wherein the sensor comprises a fluid level sensor adapted to be positioned in the reservoir.

6. The system of claim 1, wherein the sensor comprises a soil sensor adapted to be embedded in a soil sample.

7. The system of claim 1, wherein the pump comprises a positive displacement pump.

8. A method for fertilizing soil, comprising:
(a) flowing water through a flowline;
(b) pumping an additive directly into the flowline, wherein the additive mixes with the water; and
(c) spraying the additive and water mixture through a sprinkler head.

9. The method of claim 8, further comprising sensing at least one characteristic of the additive, and transmitting feedback data to control the rate of additive into the flowline.

10. The method of claim 9, wherein the sensing comprises determining a flow rate of the additive and water mixture in the flowline.

11. The method of claim 9, wherein the sensing comprises determining a pH level of the additive and water mixture in the flowline.

12. The method of claim 9, wherein the sensing comprises determining a characteristic of the additive and water mixture, and varying the pumping flow rate in response to the characteristic.

13. The method of claim 9, wherein the sensing comprises determining the additive composition in a soil sample.

14. The method of claim 9, wherein the pumping comprises pumping the additive from a reservoir directly into the flowline, and wherein the sensing comprises determining a fluid level of the additive in the reservoir.

15. The method of claim 9, wherein the sensing comprises reading the feedback data in increments of 50 milliseconds or more.

16. The method of claim 8, wherein the pumping comprises pumping at a flow rate range of 0-150 gallons per hour.

17. The method of claim 8, wherein the pumping comprises rotating a progressive cavity pump rotor and pumping the additive into the flowline at a constant flow rate per revolution of the rotor.

18. A method for fertilizing soil, comprising:
(a) flowing water through an underground flowline;
(b) with a progressive cavity pump, pumping an additive directly into the flowline, creating a mixture of the additive and the water in the flowline;
(c) spraying the mixture through a sprinkler head;
(d) sensing at least one characteristic of the additive; and
(e) transmitting the characteristic through a feedback loop to control the pumping rate of the additive into the flowline.

19. The method of claim 18, wherein the sensing comprises determining a flow rate of the additive and water mixture in the flowline.

20. The method of claim 18, wherein the sensing comprises determining a pH level of the additive and water mixture in the flowline.
